(19) United States
(12) Patent Application Publication
(10) Pub. No.: US 2019/0026793 A1
(43) Pub. Date: Jan. 24, 2019

(54) VIRTUAL REALITY BASED HOTEL SERVICES ANALYSIS AND PROCUREMENT

(71) Applicant: Accenture Global Solutions Limited, Dublin 4 (IE)

(72) Inventor: Daryl ROLLON, Cavite (PH)

(73) Assignee: Accenture Global Solutions Limited, Dublin 4 (IE)

(21) Appl. No.: 16/032,894

(22) Filed: Jul. 11, 2018

Related U.S. Application Data
(60) Provisional application No. 62/533,747, filed on Jul. 18, 2017.

(51) Int. Cl. G06Q 30/02; G06Q 50/12; G06F 3/01; G06K 9/00; H04W 4/021; G06T 19/00

(52) U.S. Cl. CPC G06Q 30/0281; G06Q 50/12; G06T 19/003; G06K 9/00671; H04W 4/021; G06F 3/013

(57) ABSTRACT

In some examples, virtual reality based hotel services analysis and procurement may include ascertaining an attribute associated with a user, and ascertaining a preference associated with the user. Virtual reality based hotel services analysis and procurement may include generating, based on the ascertained attribute and preference, and based on a virtual reality device, a virtual reality view of a hotel service of a plurality of hotel services offered by a hotel services provider, and analyzing a gaze of the user with respect to a feature of the virtual reality view of the hotel service being viewed by the user. Virtual reality based hotel services analysis and procurement may further include modifying the virtual reality view of the hotel service being viewed by the user, and controlling procurement of the hotel service by the user.

### PRIORITY

This application is a Non-Provisional Application of commonly assigned and co-pending U.S. Provisional Application Ser. No. 62/533,747, filed Jul. 18, 2017, the disclosure of which is hereby incorporated by reference in its entirety.

### BACKGROUND

In a hotel services environment, a potential guest may view examples of rooms online, and select a room from available rooms. The examples of the rooms may include sample rooms that the hotel may stage to attract customers. For example, a hotel may stage a room with open windows, flowers, edibles of different types, clothing articles, etc.

### BRIEF DESCRIPTION OF DRAWINGS

Features of the present disclosure are illustrated by way of example and not limited in the following figure(s), in which like numerals indicate like elements, in which:

FIG. 1 illustrates a layout of a virtual reality based hotel services analysis and procurement apparatus in accordance with an example of the present disclosure;

FIG. 2 illustrates a logical layout of the virtual reality based hotel services analysis and procurement apparatus of FIG. 1 in accordance with an example of the present disclosure;

FIG. 3 illustrates an example display to illustrate operation of the virtual reality based hotel services analysis and procurement apparatus of FIG. 1 in accordance with an example of the present disclosure;

FIG. 4 illustrates an example display to illustrate operation of the virtual reality based hotel services analysis and procurement apparatus of FIG. 1 in accordance with an example of the present disclosure;

FIG. 5 illustrates an example block diagram for virtual reality based hotel services analysis and procurement in accordance with an example of the present disclosure;

FIG. 6 illustrates a flowchart of an example method for virtual reality based hotel services analysis and procurement in accordance with an example of the present disclosure; and

FIG. 7 illustrates a further example block diagram for virtual reality based hotel services analysis and procurement in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Virtual reality based hotel services analysis and procurement apparatuses, methods for virtual reality based hotel services analysis and procurement, and non-transitory computer readable media having stored thereon machine readable instructions to provide virtual reality based hotel services analysis and procurement are disclosed herein. The apparatuses, methods, and non-transitory computer readable media disclosed herein provide for virtual reality based hotel services analysis and procurement by ascertaining an attribute associated with a user, and ascertaining a preference associated with the user. The apparatuses, methods, and non-transitory computer readable media disclosed herein provide for virtual reality based hotel services analysis and procurement by generating, based on the ascertained attribute and preference, a virtual reality view of a hotel service of a plurality of hotel services offered by a hotel services provider, and analyzing a gaze of the user with respect to a feature of the virtual reality view of the hotel service being viewed by the user. The apparatuses, methods, and non-transitory computer readable media disclosed herein further provide for virtual reality based hotel services analysis and procurement by modifying, based on the analysis of the gaze of the user, the virtual reality view of the hotel service being viewed by the user, and controlling, based on the modification of the virtual reality view of the hotel service being viewed by the user, procurement of the hotel service by the user.

The apparatuses, methods, and non-transitory computer readable media disclosed herein provide a technical solution to technical problems related, for example, to hotel services procurement. In this regard, the apparatuses, methods, and non-transitory computer readable media disclosed herein provide a technical solution of an immersive experience where a user (e.g., a customer) may be immersed in the content of the pictures/videos related, for example, to a hotel service, minimization of distractions, and greater attention to the conveyed message. In this regard, the apparatuses, methods, and non-transitory computer readable media disclosed herein provide a technical solution of interactive navigation and a street view to facilitate navigation with respect to hotel services, for example, while a user is in the hotel premises.

The apparatuses, methods, and non-transitory computer readable media disclosed herein provide a lasting impression, where interaction and participation in events may last longer in a user's memory compared to still pictures and texts. In this regard, a hotel's brand may include a greater memory recall for users when booking reservations at a future date.

The apparatuses, methods, and non-transitory computer readable media disclosed herein provide a guarantee of user satisfaction. In this regard, with respect to emphasis on customer experience, customers may be provided an option to see and experience a hotel before booking. This will ensure that users will book if they like the look-and-feel of the experience. In this regard, the possibility of a user not being satisfied with their hotel experience may be reduced, resulting in generation of higher rated reviews for a hotel, and potential future customers.

According to an example, the apparatus may be implemented as a mobile application. In this regard, the mobile application may be used, for example, with a virtual reality viewer.

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

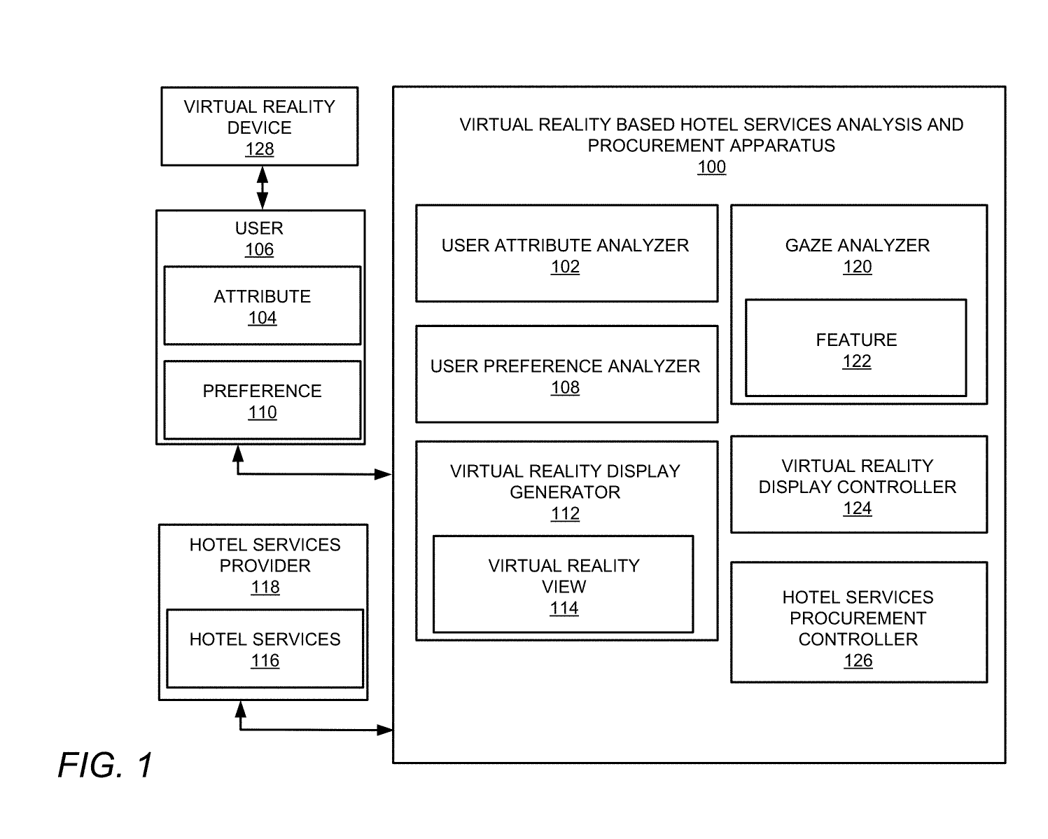

FIG. 1 illustrates a layout of an example virtual reality based hotel services analysis and procurement apparatus (hereinafter also referred to as “apparatus 100”).

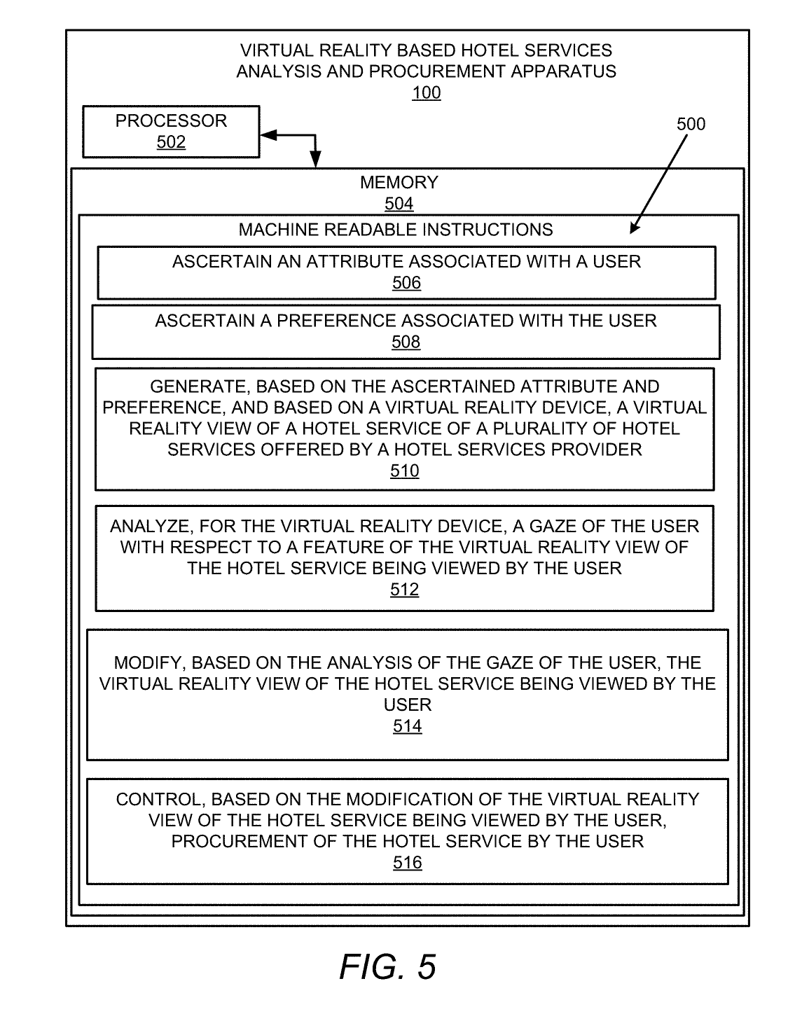

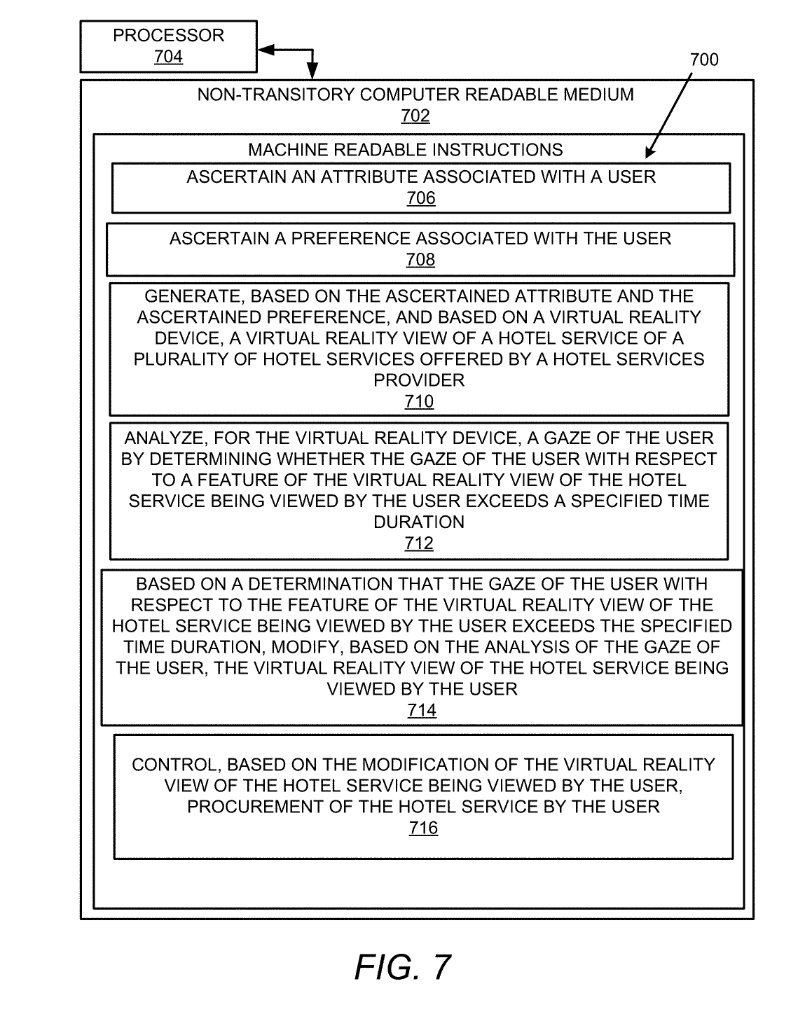

Referring to FIG. 1, the apparatus 100 may include a user attribute analyzer 102 that is executed by at least one hardware processor (e.g., the hardware processor 502 of FIG. 5, and/or the hardware processor 704 of FIG. 7) to ascertain an attribute 104 associated with a user 106.

A user preference analyzer 108 that is executed by the at least one hardware processor (e.g., the hardware processor 502 of FIG. 5, and/or the hardware processor 704 of FIG. 7) may ascertain a preference 110 associated with the user 106.

A virtual reality display generator 112 that is executed by the at least one hardware processor (e.g., the hardware processor 502 of FIG. 5, and/or the hardware processor 704 of FIG. 7) may generate, based on the ascertained attribute and preference, and based on a virtual reality device 128, a virtual reality view 114 of a hotel service of a plurality of hotel services 116 offered by a hotel services provider 118. A hotel service may include, for example, a hotel room, a spa, a lunch or dinner, associated car rental, sight-seeing, etc. An example of a virtual reality device 128 may include a HOLOLENS, GOOGLE CARDBOARD, SAMSUNG GEAR VR, or another such device.

According to examples disclosed herein, the virtual reality display generator 112 may generate, based on the ascertained attribute and the ascertained preference, and based on the virtual reality device 128, the virtual reality view of the hotel service of the plurality of hotel services offered by the hotel services provider by generating, based on the ascertained attribute that includes an age of the user, a gender of the user, and/or a location of the user, and based on the virtual reality device, the virtual reality view of the hotel service of the plurality of hotel services offered by the hotel services provider.

According to examples disclosed herein, the virtual reality display generator 112 may generate, based on the ascertained attribute and the ascertained preference, and based on the virtual reality device, the virtual reality view of the hotel service of the plurality of hotel services offered by the hotel services provider by generating, based on the ascertained attribute and the ascertained preference that includes a type of virtual reality view, a hotspot location, and/or a hotspot event, and based on the virtual reality device, the virtual reality view of the hotel service of the plurality of hotel services offered by the hotel services provider.

According to examples disclosed herein, the hotspot event may include a navigate hotspot event to trigger another virtual reality view of the hotel service being viewed by the user, an information hotspot event to display an information dialogue related to the virtual reality view of the hotel service being viewed by the user, and/or a purchase hotspot event to open a purchase dialogue related to the virtual reality view of the hotel service being viewed by the user.

A gaze analyzer 120 that is executed by the at least one hardware processor (e.g., the hardware processor 502 of FIG. 5, and/or the hardware processor 704 of FIG. 7) may analyze, for the virtual reality device 128, a gaze of the user 106 with respect to a feature 122 of the virtual reality view 114 of the hotel service being viewed by the user 106. For example, the feature may include a door of a hotel room, where the user 106 may gaze at the door to enter the hotel room. According to another example, the feature may include a bed, where the user 106 may gaze at the bed to select a bed size. According to another example, the feature may include a window view, where the user 106 may gaze at the window view to select a certain type of view and hotel room (e.g., ocean front, etc.). The gaze may be created using, for example, the reticulum functionality of three.js. The reticulum functionality may include the feature to set gaze action such as positioning, gaze over, and out of specific objects. When the user 106 gazes at a specific object (e.g., a hotspot object), the reticulum may trigger the event for that specific hotspot object.

A virtual reality display controller 124 that is executed by the at least one hardware processor (e.g., the hardware processor 502 of FIG. 5, and/or the hardware processor 704 of FIG. 7) may modify, based on the analysis of the gaze of the user 106, the virtual reality view 114 of the hotel service being viewed by the user 106.

In this regard, when the user 106 gazes at a navigate hotspot object, this gaze may trigger a function to retrieve a views parameter associated to the hotspot object such as identification (ID), name, and events.

Three events may be associated to a hotspot object (e.g., navigate, information, and purchase). The navigate event may be used to move to another view. The navigate event may call a function to retrieve the background view image and hotspots location, and render the background view image and hotspots location to the virtual reality view using, for example, THREE.TextureLoader of a three.js feature. The information event may be used to display an information dialogue. The information event may call a display function to render a new object that contains information with respect to the virtual reality view. The purchase event may be used to open a purchase dialogue. The purchase event may display a purchase to load a purchase content display.

According to examples disclosed herein, the gaze analyzer 120 may analyze, for the virtual reality device, the gaze of the user with respect to the feature of the virtual reality view of the hotel service being viewed by the user, and the virtual reality display controller 124 may modify, based on the analysis of the gaze of the user, the virtual reality view of the hotel service being viewed by the user by analyzing, for the virtual reality device, the gaze of the user with respect to the feature that includes a door of the hotel service that includes a hotel room being viewed by the user, and modifying, based on the analysis of the gaze of the user, the virtual reality view of the hotel service being viewed by the user by allowing the user to enter the hotel room being viewed by the user.

According to examples disclosed herein, the gaze analyzer 120 may analyze, for the virtual reality device, the gaze of the user with respect to the feature of the virtual reality view of the hotel service being viewed by the user, and the virtual reality display controller 124 may modify, based on the analysis of the gaze of the user, the virtual reality view of the hotel service being viewed by the user by analyzing, for the virtual reality device, the gaze of the user with respect to the feature that includes a bed of the hotel service that includes a hotel room being viewed by the user, and modifying, based on the analysis of the gaze of the user, the virtual reality view of the hotel service being viewed by the user by generating a menu option to select a bed size for the hotel room being viewed by the user.

According to examples disclosed herein, the gaze analyzer 120 may analyze, for the virtual reality device, the gaze of the user with respect to the feature of the virtual reality view of the hotel service being viewed by the user, and the virtual reality display controller 124 may modify, based on the analysis of the gaze of the user, the virtual reality view of the hotel service being viewed by the user by analyzing, for the virtual reality device, the gaze of the user with respect to the feature that includes a window of the hotel service that includes a hotel room being viewed by the user, and modifying, based on the analysis of the gaze of the user, the virtual reality view of the hotel service being viewed by the user by generating a menu option to select a hotel room view for the hotel room being viewed by the user.

According to examples disclosed herein, the gaze analyzer 120 may analyze, for the virtual reality device 128, the gaze of the user with respect to the feature of the virtual reality view of the hotel service being viewed by the user, and the virtual reality display controller 124 may modify, based on the analysis of the gaze of the user, the virtual reality view of the hotel service being viewed by the user by analyzing, for the virtual reality device, the gaze of the user by determining whether the gaze of the user with respect to the feature of the virtual reality view of the hotel service being viewed by the user exceeds a specified time duration (e.g., 30 seconds), and based on a determination that the gaze of the user with respect to the feature of the virtual reality view of the hotel service being viewed by the user exceeds the specified time duration, modifying, based on the analysis of the gaze of the user, the virtual reality view of the hotel service being viewed by the user.

According to examples disclosed herein, the gaze analyzer 120 may analyze, for the virtual reality device 128, the gaze of the user with respect to the feature of the virtual reality view of the hotel service being viewed by the user, and the virtual reality display controller 124 may modify, based on the analysis of the gaze of the user, the virtual reality view of the hotel service being viewed by the user by analyzing, for the virtual reality device, the gaze of the user by determining whether the gaze of the user with respect to the feature of the virtual reality view of the hotel service being viewed by the user is less than a specified time duration (e.g., 30 seconds), and based on a determination that the gaze of the user with respect to the feature of the virtual reality view of the hotel service being viewed by the user is less than the specified time duration, delaying modification, based on the analysis of the gaze of the user, of the virtual reality view of the hotel service being viewed by the user until the gaze of the user with respect to the feature of the virtual reality view of the hotel service being viewed by the user meets or exceeds the specified time duration.

A hotel services procurement controller 126 that is executed by the at least one hardware processor (e.g., the hardware processor 502 of FIG. 5, and/or the hardware processor 704 of FIG. 7) is to control, based on the modification of the virtual reality view 114 of the hotel service being viewed by the user 106, procurement of the hotel service by the user 106.

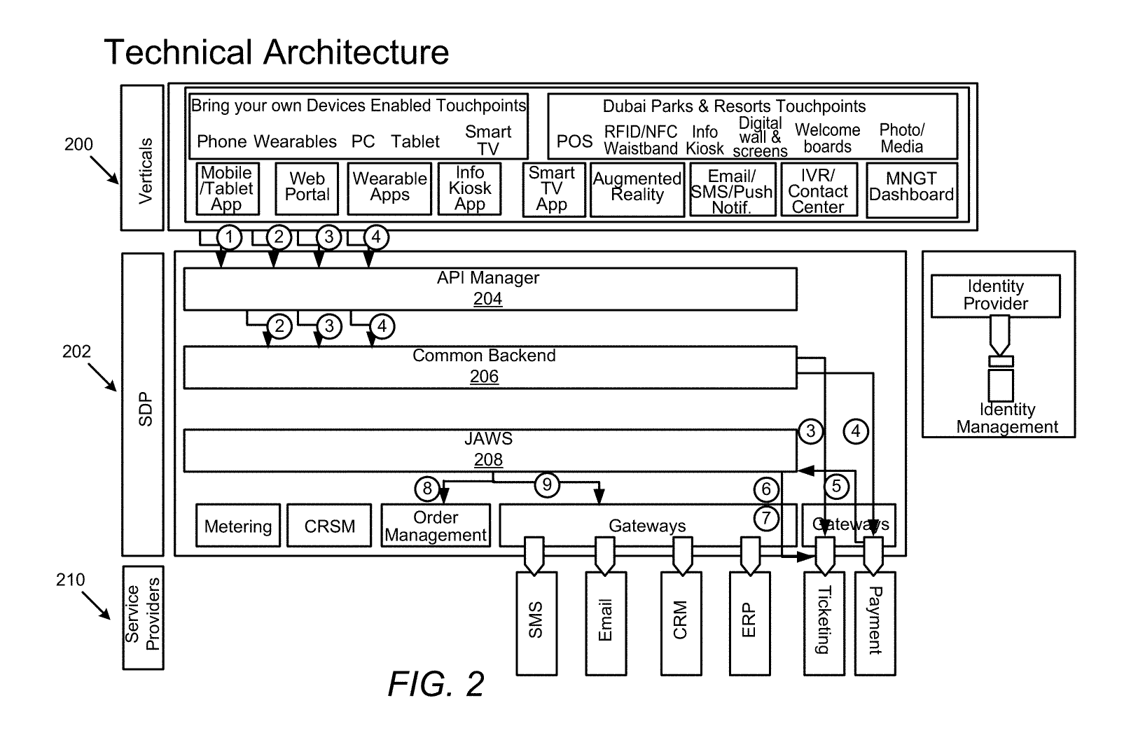

FIG. 2 illustrates a logical layout of the apparatus 100 in accordance with an example of the present disclosure.

Referring to FIG. 2, the logical layout may include verticals at 200 that include various type of interfaces for mobile/tablet applications, web portal, wearable device applications, kiosk applications, etc. At 202, the Service Delivery Platform (SDP) may include an application programming interface (API) manager 204, common backend at 206, and Just Another Web Storage (JAWS) at 208. In this regard, when the user 106 selects a particular option at 200, the selection may trigger an API call via the API manager 204. The API manager 204 may provide a security API layer that will serve as an interface for common backend API. The common backend at 206 may include any business logic related to the virtual reality view 114 (e.g., prices, promotions being offered). The common backend at 206 may also provide for saving of any information related to the user 106. Further processing from JAWS at 208 may include metering, customer relationship subscription management (CRSM), an order manager, and gateways. The gateways may provide access to Short Message Service (SMS), e-mail, customer relationship management (CRM), Enterprise Resource Planning (ERP), ticketing, and payment. The JAWS at 208 may orchestrate any flows related to the metering, CRSM, order manager, etc. For example, the JAWS at 208 may provide for contacting of credit-card agencies with respect to payment associated with a hotel service. The metering may account for a history of API calls related to a particular transaction. The CRSM platform may include records related to the user 106, and other users. The order manager may account for and control an order of different actions performed by the user 106. The SMS, e-mail, CRM, ERP, ticketing, and payment may be included in a service provider layer at 210. The logical layout may also include a user identity provider 212 to provide for identity management of the user 106, for example, for booking, payment, as well as virtual reality viewing purposes (e.g., a user 106 may be provided with different options to view a particular virtual reality view based on their identity that may include their name, gender, age, etc.).

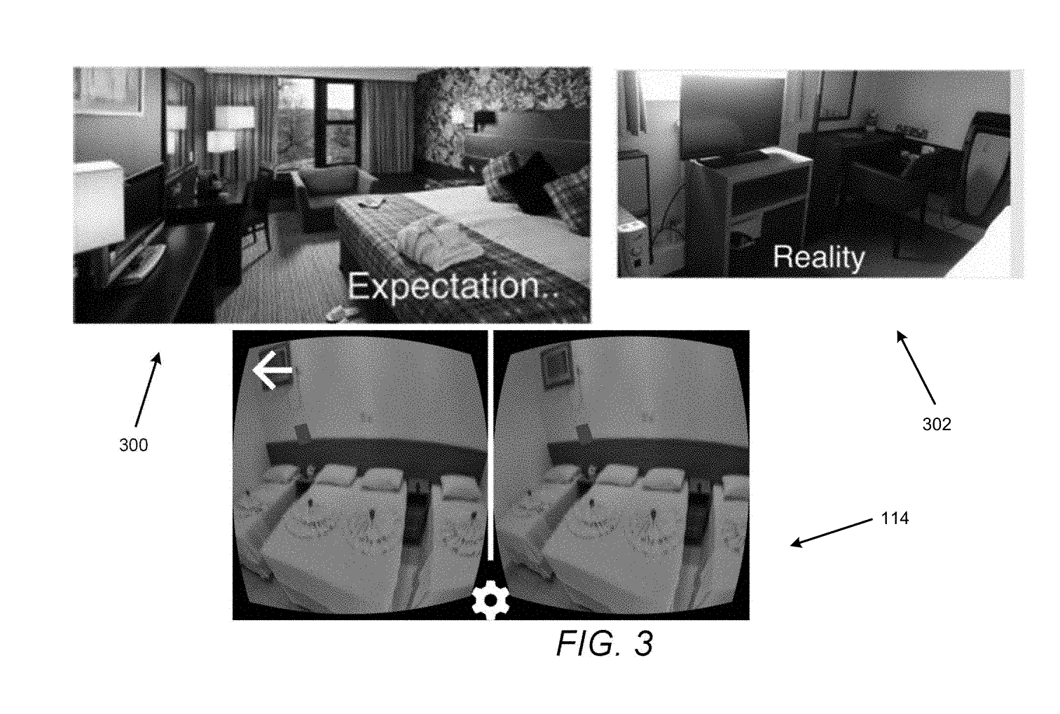

FIG. 3 illustrates an example display to illustrate operation of the apparatus 100 in accordance with an example of the present disclosure.

Referring to FIG. 3, an example display may include a virtual reality view 114 of an actual room (e.g., the hotel service as disclosed herein). For example, for a user 106 expecting a room at 300, where in reality the user may have previously received a room as shown, for example, at 302, the virtual reality view 114 may provide a display of the actual room. In this manner, the virtual reality view 114 may bridge the gap between expectation and reality when availing a hotel service. The virtual reality view 114 may also address the technical challenges associated with booking reservations where the reality of hotel services or amenities do not meet the expectations of the user, which impacts both the user's experience and the hotel's reputation.

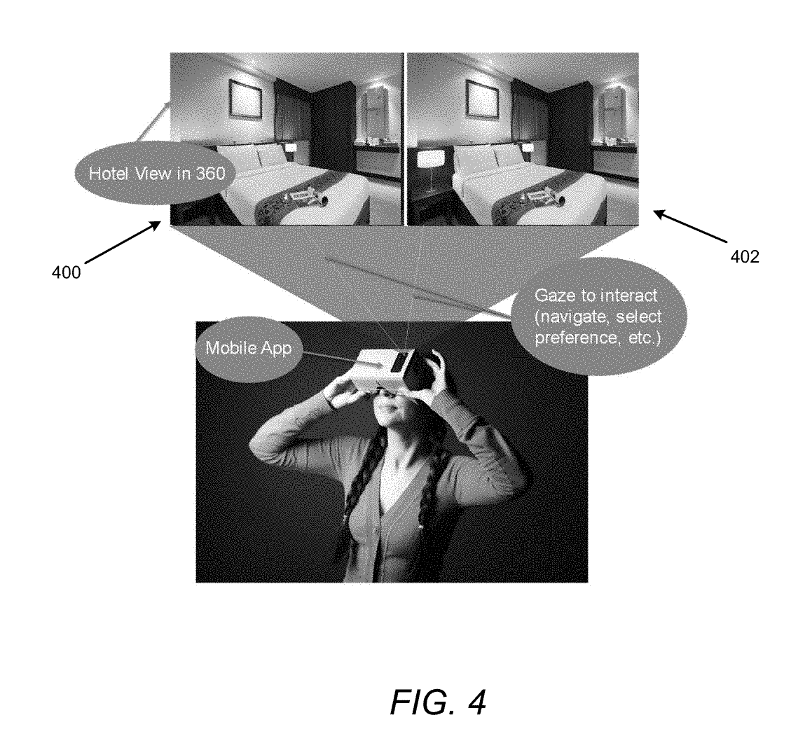

FIG. 4 illustrates an example display to illustrate operation of the apparatus 100 in accordance with an example of the present disclosure.

Referring to FIG. 4, for an example of a hotel service including a hotel room, at 400, a 360° view including images and/or videos of the hotel and/or the hotel room may be rendered. According to an example, the 360° view may be rendered using WebVR, which may include a Javascript API for rendering virtual reality content in the web. The implementation of WebVR may provide for the maximization of mobility. WebVR may also provide for the apparatus 100 to be implemented in different virtual reality capable devices, without the need to maintain multiple code bases.

At 402, the user 106 may gaze at the image/video of the hotel room to interact with the hotel room. For example, the user 106 may gaze at a door to enter the hotel room. When the user gazes a specific hotspot object (e.g., the door), the hotspot object may include a specific event (e.g., navigate, information, purchase), as disclosed herein. According to another example, the user 106 may gaze at a bed, and in response, the virtual reality view 114 may include a display of a plurality of options for different beds (e.g., queen, king, color, etc.). According to another example, if the user 106 spends less than a specified threshold amount of time (e.g., 30 seconds) in the hotel room, a price menu may not be presented to the user 106. Alternatively, if the user 106 spends greater than the specified threshold amount of time in the hotel room, the price menu may be presented to the user 106. Additionally, if the user 106 includes a particular attribute (e.g., a frequent traveler, etc.), the user 106 may be presented with offers for other amenities (e.g., spas, gym, car pickup, etc.), as well as virtual reality views for the other amenities. Thus, the user 106 may perform the entire booking experience for the hotel service without being physically present at a particular hotel.

With respect to customization of the virtual reality view as disclosed herein with reference to element 402 of FIG. 4, the virtual reality display generator 112 may generate, based on the ascertained attribute and preference of the user 106, the virtual reality view 114 of a hotel service of a plurality of hotel services 116 offered by the hotel services provider 118. In this regard, with respect to the virtual reality view 114, the hotel services provider 118 may perform operations such as uploading a 360° background image/video, selecting a hotspots location, for example, by x and y coordinates (where selecting a hotspots location means that the hotel services provider 118 can position the hotspot location in a virtual reality display), and selecting a hotspot event. Examples of hotspot events may include navigate, information, and purchase. The navigate hotspot event may be used to trigger another view, for example, of the hotel room or a feature of the hotel room. The information hotspot event may be used to display an information dialogue related to a view. The purchase hotspot event may be used to open a purchase dialogue related to a view.

With respect to procurement of the hotel service by the user 106, as disclosed herein, the hotel services procurement controller 126 may control, based on the modification of the virtual reality view 114 of the hotel service being viewed by the user 106, procurement of the hotel service by the user 106. In this regard, a procurement window may be called on the virtual reality view 114. Once a button (e.g., a menu option) for the virtual reality view 114 of the room has been triggered by the user 106, an initializeVR function may call the following REST APIs (e.g., at 204 of FIG. 2). The first REST API may include “RetrieveViews” and the second REST API may include “RetrieveHotspots.”

The “RetrieveViews” API may retrieve all virtual reality views, for example, by a RoomID parameter. An example request for retrieval of a virtual reality view may include:

“viewRequest”{
“room ID”: “1”
}

In this regard, an example response to the aforementioned request for retrieval of a virtual reality view may include:

```
“viewResponse”{
  “viewID”: “1”,
  “name”: “Double”,
  description”:“description”
  “backgroundDisplay”: “room1.jpg”
}
```

Thus, for the example request for retrieval of a virtual reality view for “room ID”: “1”, corresponding information such as “name”: “Double” (which may represent a double room type), “description”:“description” (which may include description related to the double room type”, and “backgroundDisplay”: “room1.jpg” (which may include an image of the double room type) may be retrieved.

The “RetrieveHotspots” API may display the hotspot location and associated events based on the viewID parameter from “RetrieveViews API.” An example request for display of the hotspot location and associated events may include:

“hotspotsRequest”{
“viewID”: “1”
}

In this regard, an example response to the aforementioned request for display of the hotspot location and associated events may include:

```
“hotspotResponse”{
        “hotspot”:[ {
                “hotspotID”: “1”,
                “name”: “hotspotNavigateRoom1”,
                “description”:”navigate”,
                “xCoordinate”: “50”,
                “yCoordinate”: “90”,
                “iconDisplay”: “icon1.png”,
                “events”: [{
                        “eventID”: “1”,
                        “eventType”: “navigate”,
                        “eventAction”: “roomIDparameter”
                }]
        }]
}
```

Thus, for the example request for display of the hotspot location and associated events for “viewId”: “1”, corresponding information such as “name”: “hotspotNavigateRoom1” (where “hotspotNavigateRoom1” may define the name of the specific view), “description”:“navigate” (where “navigate” may be used to define the description of the specific view]), “xCoordinate”: “50”, “yCoordinate”: “90” (where “xCoordinate” may be used to set the x position of the object, and “yCoordinate” may be used to set the y position of the object), “iconDisplay”: “icon1.png” (where “icon1.png” may represent the image display of the specific hotspot), “events”: [{“eventID”: “1”, “eventType”: “navigate” (where “eventType” may identify what the event will perform, and “navigate” may be used to move to the next view), “eventAction”: “roomIDparameter” (where “roomIDparameter” may represent a parameter used to identify the nextView which will be the parameter of an actionEvent function) may be retrieved.

With respect to procurement of the hotel service by the user 106, after retrieval of all of the information from the API, a “displayBackground” function may be called to render the view in virtual reality using, for example, a Three.JS library (the Three.JS library may represent an opensource library that renders the objects into virtual reality). The “displayBackground” function may change the view display by replacing the current display loaded, for example, in a THREE.TextureLoader that renders the view display background.

Further, with respect to procurement of the hotel service by the user 106, a “displayHotspots” function may be triggered once a certain view has been displayed. The “displayHotspots” function may create a three-dimensional mesh object using, for example, Three. MeshBasicMaterial based on the values of hotspot objects position and display from a RetrieveHotspots API response.

The apparatus 100 may also provide for various related aspects such as solicitation of feedback from users based on the virtual environment based interaction with the hotel.

The apparatus 100 may also provide for various offerings related to the hotel services, such as theme parks, airline offerings, sights, events, automobile rental, etc.

The apparatus 100 may be applied to a variety of industries other than or in conjunction with hotel services. For example, the apparatus 100 may be applied to theme parks for preview of rides, sights, and events, aquariums and ocean parks, travel and booking, beach resorts, airline offerings, etc. The apparatus 100 may also be applied to areas such as shopping (e.g., ticket purchase, store product purchase, etc.), live streaming (e.g., buying and viewing of live events occurring in a hotel), gamification (e.g., enticing users to view advertisements, buy products, or participate in events, in exchange for points or discounts.)

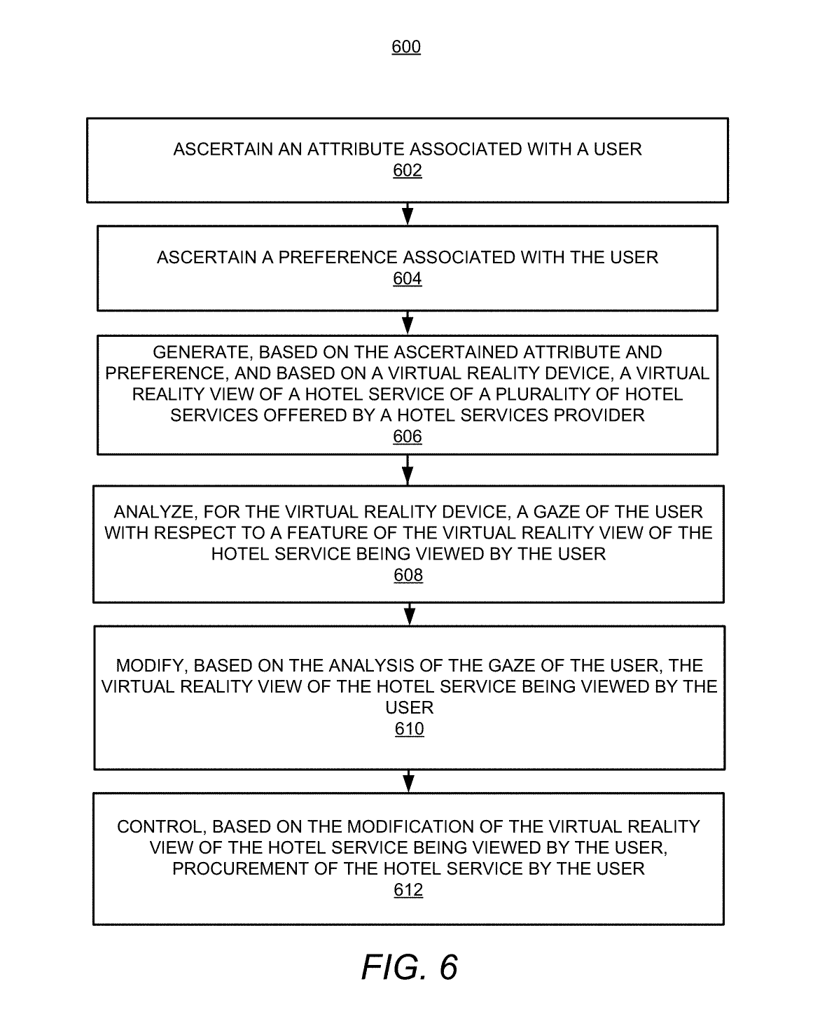

FIGS. 5-7 respectively illustrate an example block diagram 500, a flowchart of an example method 600, and a further example block diagram 700 for virtual reality based hotel services analysis and procurement, according to examples. The block diagram 500, the method 600, and the block diagram 700 may be implemented on the apparatus 100 described above with reference to FIG. 1 by way of example and not of limitation. The block diagram 500, the method 600, and the block diagram 700 may be practiced in other apparatus. In addition to showing the block diagram 500, FIG. 5 shows hardware of the apparatus 100 that may execute the instructions of the block diagram 500. The hardware may include a processor 502, and a memory 504 storing machine readable instructions that when executed by the processor cause the processor to perform the instructions of the block diagram 500. The memory 504 may represent a non-transitory computer readable medium. FIG. 6 may represent an example method for virtual reality based hotel services analysis and procurement, and the steps of the method. FIG. 7 may represent a non-transitory computer readable medium 702 having stored thereon machine readable instructions to provide virtual reality based hotel services analysis and procurement according to an example. The machine readable instructions, when executed, cause a processor 704 to perform the instructions of the block diagram 700 also shown in FIG. 7.

The processor 502 of FIG. 5 and/or the processor 504 of FIG. 5 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 702 of FIG. 7), such as hardware storage devices (e.g., RAM (random access memory), ROM (read only memory), EPROM (erasable, programmable ROM), EEPROM (electrically erasable, programmable ROM), hard drives, and flash memory). The memory 504 may include a RAM, where the machine readable instructions and data for a processor may reside during runtime.

Referring to FIGS. 1-5, and particularly to the block diagram 500 shown in FIG. 5, the memory 504 may include instructions 506 to ascertain an attribute 104 associated with a user 106.

The processor 502 may fetch, decode, and execute the instructions 508 to ascertain a preference 110 associated with the user 106.

The processor 502 may fetch, decode, and execute the instructions 510 to generate, based on the ascertained attribute 104 and preference 110, and based on a virtual reality device 128, a virtual reality view 114 of a hotel service of a plurality of hotel services 116 offered by a hotel services provider 118.

The processor 502 may fetch, decode, and execute the instructions 512 to analyze, for the virtual reality device 128, a gaze of the user 106 with respect to a feature 122 of the virtual reality view 114 of the hotel service being viewed by the user 106.

The processor 502 may fetch, decode, and execute the instructions 514 to modify, based on the analysis of the gaze of the user 106, the virtual reality view 114 of the hotel service being viewed by the user 106.

The processor 502 may fetch, decode, and execute the instructions 516 to control, based on the modification of the virtual reality view 114 of the hotel service being viewed by the user 106, procurement of the hotel service by the user 106.

Referring to FIGS. 1-4 and 6, and particularly FIG. 6, for the method 600, at block 602, the method may include ascertaining, by a processor, an attribute 104 associated with a user 106.

At block 604, the method may include ascertaining a preference 110 associated with the user 106.

At block 606, the method may include generating, based on the ascertained attribute 104 and preference 110, and based on a virtual reality device 128, a virtual reality view 114 of a hotel service of a plurality of hotel services 116 offered by a hotel services provider 118. The hotel service may include a hotel room, or a service associated with the hotel room.

At block 608, the method may include analyzing, for the virtual reality device 128, a gaze of the user 106 with respect to a feature 122 of the virtual reality view 114 of the hotel service being viewed by the user 106.

At block 610, the method may include modifying, based on the analysis of the gaze of the user 106, the virtual reality view 114 of the hotel service being viewed by the user 106.

At block 612, the method may include controlling, based on the modification of the virtual reality view 114 of the hotel service being viewed by the user 106, procurement of the hotel service by the user 106.

Referring to FIGS. 1-4 and 7, and particularly FIG. 7, for the block diagram 700, the non-transitory computer readable medium 702 may include instructions 706 to ascertain an attribute 104 associated with a user 106.

The processor 704 may fetch, decode, and execute the instructions 706 to ascertain a preference 110 associated with the user 106.

The processor 704 may fetch, decode, and execute the instructions 710 to generate, based on the ascertained attribute 104 and preference 110, and based on a virtual reality device 128, a virtual reality view 114 of a hotel service of a plurality of hotel services 116 offered by a hotel services provider 118.

The processor 704 may fetch, decode, and execute the instructions 712 to analyze, for the virtual reality device, a gaze of the user 106 by determining whether the gaze of the user with respect to a feature 122 of the virtual reality view 114 of the hotel service being viewed by the user 106 exceeds a specified time duration.

Based on a determination that the gaze of the user with respect to the feature of the virtual reality view of the hotel service being viewed by the user exceeds the specified time duration, the processor 704 may fetch, decode, and execute the instructions 714 to modify, based on the analysis of the gaze of the user 106, the virtual reality view 114 of the hotel service being viewed by the user 106.

The processor 704 may fetch, decode, and execute the instructions 716 to control, based on the modification of the virtual reality view 114 of the hotel service being viewed by the user 106, procurement of the hotel service by the user 106.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A virtual reality based hotel services analysis and procurement apparatus comprising:
a user attribute analyzer, executed by at least one hardware processor, to
ascertain an attribute associated with a user;
a user preference analyzer, executed by the at least one hardware processor, to
ascertain a preference associated with the user;
a virtual reality display generator, executed by the at least one hardware processor, to
generate, based on the ascertained attribute and the ascertained preference, and based on a virtual reality device, a virtual reality view of a hotel service of a plurality of hotel services offered by a hotel services provider;
a gaze analyzer, executed by the at least one hardware processor, to
analyze, for the virtual reality device, a gaze of the user with respect to a feature of the virtual reality view of the hotel service being viewed by the user;
a virtual reality display controller, executed by the at least one hardware processor, to
modify, based on the analysis of the gaze of the user, the virtual reality view of the hotel service being viewed by the user; and
a hotel services procurement controller, executed by the at least one hardware processor, to
control, based on the modification of the virtual reality view of the hotel service being viewed by the user, procurement of the hotel service by the user.

2. The virtual reality based hotel services analysis and procurement apparatus according to claim 1, wherein the virtual reality display generator is executed by the at least one hardware processor to generate, based on the ascertained attribute and the ascertained preference, and based on the virtual reality device, the virtual reality view of the hotel service of the plurality of hotel services offered by the hotel services provider by:
generating, based on the ascertained attribute that includes at least one of an age of the user, a gender of the user, or a location of the user, and based on the virtual reality device, the virtual reality view of the hotel service of the plurality of hotel services offered by the hotel services provider.

3. The virtual reality based hotel services analysis and procurement apparatus according to claim 1, wherein the virtual reality display generator is executed by the at least one hardware processor to generate, based on the ascertained attribute and the ascertained preference, and based on the virtual reality device, the virtual reality view of the hotel service of the plurality of hotel services offered by the hotel services provider by:
generating, based on the ascertained attribute and the ascertained preference that includes at least one of a type of virtual reality view, a hotspot location, or a hotspot event, and based on the virtual reality device, the virtual reality view of the hotel service of the plurality of hotel services offered by the hotel services provider.

4. The virtual reality based hotel services analysis and procurement apparatus according to claim 3, wherein the hotspot event includes a navigate hotspot event to trigger another virtual reality view of the hotel service being viewed by the user, an information hotspot event to display an information dialogue related to the virtual reality view of the hotel service being viewed by the user, or a purchase hotspot event to open a purchase dialogue related to the virtual reality view of the hotel service being viewed by the user.

5. The virtual reality based hotel services analysis and procurement apparatus according to claim 1, wherein the hotel service being viewed by the user includes at least one of a hotel room, or a service associated with the hotel room.

6. The virtual reality based hotel services analysis and procurement apparatus according to claim 1, wherein the gaze analyzer is executed by the at least one hardware processor to analyze, for the virtual reality device, the gaze of the user with respect to the feature of the virtual reality view of the hotel service being viewed by the user, and the virtual reality display controller is executed by the at least one hardware processor to modify, based on the analysis of the gaze of the user, the virtual reality view of the hotel service being viewed by the user by:
analyzing, for the virtual reality device, the gaze of the user with respect to the feature that includes a door of the hotel service that includes a hotel room being viewed by the user; and
modifying, based on the analysis of the gaze of the user, the virtual reality view of the hotel service being viewed by the user by allowing the user to enter the hotel room being viewed by the user.

7. The virtual reality based hotel services analysis and procurement apparatus according to claim 1, wherein the gaze analyzer is executed by the at least one hardware processor to analyze, for the virtual reality device, the gaze of the user with respect to the feature of the virtual reality view of the hotel service being viewed by the user, and the virtual reality display controller is executed by the at least one hardware processor to modify, based on the analysis of the gaze of the user, the virtual reality view of the hotel service being viewed by the user by:
analyzing, for the virtual reality device, the gaze of the user with respect to the feature that includes a bed of the hotel service that includes a hotel room being viewed by the user; and
modifying, based on the analysis of the gaze of the user, the virtual reality view of the hotel service being viewed by the user by generating a menu option to select a bed size for the hotel room being viewed by the user.

8. The virtual reality based hotel services analysis and procurement apparatus according to claim 1, wherein the gaze analyzer is executed by the at least one hardware processor to analyze, for the virtual reality device, the gaze of the user with respect to the feature of the virtual reality view of the hotel service being viewed by the user, and the virtual reality display controller is executed by the at least one hardware processor to modify, based on the analysis of the gaze of the user, the virtual reality view of the hotel service being viewed by the user by:
analyzing, for the virtual reality device, the gaze of the user with respect to the feature that includes a window of the hotel service that includes a hotel room being viewed by the user; and
modifying, based on the analysis of the gaze of the user, the virtual reality view of the hotel service being viewed by the user by generating a menu option to select a hotel room view for the hotel room being viewed by the user.

9. The virtual reality based hotel services analysis and procurement apparatus according to claim 1, wherein the gaze analyzer is executed by the at least one hardware processor to analyze, for the virtual reality device, the gaze of the user with respect to the feature of the virtual reality view of the hotel service being viewed by the user, and the virtual reality display controller is executed by the at least one hardware processor to modify, based on the analysis of the gaze of the user, the virtual reality view of the hotel service being viewed by the user by:
analyzing, for the virtual reality device, the gaze of the user by determining whether the gaze of the user with respect to the feature of the virtual reality view of the hotel service being viewed by the user exceeds a specified time duration; and
based on a determination that the gaze of the user with respect to the feature of the virtual reality view of the hotel service being viewed by the user exceeds the specified time duration, modifying, based on the analysis of the gaze of the user, the virtual reality view of the hotel service being viewed by the user.

10. The virtual reality based hotel services analysis and procurement apparatus according to claim 1, wherein the gaze analyzer is executed by the at least one hardware processor to analyze, for the virtual reality device, the gaze of the user with respect to the feature of the virtual reality view of the hotel service being viewed by the user, and the virtual reality display controller is executed by the at least one hardware processor to modify, based on the analysis of the gaze of the user, the virtual reality view of the hotel service being viewed by the user by:
analyzing, for the virtual reality device, the gaze of the user by determining whether the gaze of the user with respect to the feature of the virtual reality view of the hotel service being viewed by the user is less than a specified time duration; and
based on a determination that the gaze of the user with respect to the feature of the virtual reality view of the hotel service being viewed by the user is less than the specified time duration, delaying modification, based on the analysis of the gaze of the user, of the virtual reality view of the hotel service being viewed by the user until the gaze of the user with respect to the feature of the virtual reality view of the hotel service being viewed by the user meets or exceeds the specified time duration.

11. A method for virtual reality based hotel services analysis and procurement comprising:
ascertaining, by at least one hardware processor, an attribute associated with a user;
ascertaining, by the at least one hardware processor, a preference associated with the user;
generating, by the at least one hardware processor, based on the ascertained attribute and the ascertained preference, and based on a virtual reality device, a virtual reality view of a hotel service of a plurality of hotel services offered by a hotel services provider, wherein the hotel service includes at least one of a hotel room, or a service associated with the hotel room;
analyzing, by the at least one hardware processor and for the virtual reality device, a gaze of the user with respect to a feature of the virtual reality view of the hotel service being viewed by the user;
modifying, by the at least one hardware processor, based on the analysis of the gaze of the user, the virtual reality view of the hotel service being viewed by the user; and
controlling, by the at least one hardware processor, based on the modification of the virtual reality view of the hotel service being viewed by the user, procurement of the hotel service by the user.

12. The method according to claim 11, wherein generating, based on the ascertained attribute and the ascertained preference, and based on the virtual reality device, the virtual reality view of the hotel service of the plurality of hotel services offered by the hotel services provider further comprises:
generating, based on the ascertained attribute that includes at least one of an age of the user, a gender of the user, or a location of the user, and based on the virtual reality device, the virtual reality view of the hotel service of the plurality of hotel services offered by the hotel services provider.

13. The method according to claim 11, wherein generating, based on the ascertained attribute and the ascertained preference, and based on the virtual reality device, the virtual reality view of the hotel service of the plurality of hotel services offered by the hotel services provider further comprises:
generating, based on the ascertained attribute and the ascertained preference that includes at least one of a type of virtual reality view, a hotspot location, or a hotspot event, and based on the virtual reality device, the virtual reality view of the hotel service of the plurality of hotel services offered by the hotel services provider.

14. The method according to claim 13, wherein the hotspot event includes a navigate hotspot event to trigger another virtual reality view of the hotel service being viewed by the user, an information hotspot event to display an information dialogue related to the virtual reality view of the hotel service being viewed by the user, or a purchase hotspot event to open a purchase dialogue related to the virtual reality view of the hotel service being viewed by the user.

15. The method according to claim 11, wherein analyzing, for the virtual reality device, the gaze of the user with respect to the feature of the virtual reality view of the hotel service being viewed by the user, and modifying, based on the analysis of the gaze of the user, the virtual reality view of the hotel service being viewed by the user further comprises:
analyzing, for the virtual reality device, the gaze of the user with respect to the feature that includes a door of the hotel service that includes a hotel room being viewed by the user; and
modifying, based on the analysis of the gaze of the user, the virtual reality view of the hotel service being viewed by the user by allowing the user to enter the hotel room being viewed by the user.

16. The method according to claim 11, wherein analyzing, for the virtual reality device, the gaze of the user with respect to the feature of the virtual reality view of the hotel service being viewed by the user, and modifying, based on the analysis of the gaze of the user, the virtual reality view of the hotel service being viewed by the user further comprises:
analyzing, for the virtual reality device, the gaze of the user with respect to the feature that includes a bed of the hotel service that includes a hotel room being viewed by the user; and
modifying, based on the analysis of the gaze of the user, the virtual reality view of the hotel service being viewed by the user by generating a menu option to select a bed size for the hotel room being viewed by the user.

17. The method according to claim 1, wherein analyzing, for the virtual reality device, the gaze of the user with respect to the feature of the virtual reality view of the hotel service being viewed by the user, and modifying, based on the analysis of the gaze of the user, the virtual reality view of the hotel service being viewed by the user further comprises:
analyzing, for the virtual reality device, the gaze of the user with respect to the feature that includes a window of the hotel service that includes a hotel room being viewed by the user; and
modifying, based on the analysis of the gaze of the user, the virtual reality view of the hotel service being viewed by the user by generating a menu option to select a hotel room view for the hotel room being viewed by the user.

18. A non-transitory computer readable medium having stored thereon machine readable instructions, the machine readable instructions, when executed by at least one hardware processor, cause the at least one hardware processor to:
ascertain an attribute associated with a user;
ascertain a preference associated with the user;
generate, based on the ascertained attribute and the ascertained preference, and based on a virtual reality device, a virtual reality view of a hotel service of a plurality of hotel services offered by a hotel services provider;
analyze, for the virtual reality device, a gaze of the user by determining whether the gaze of the user with respect to a feature of the virtual reality view of the hotel service being viewed by the user exceeds a specified time duration;
based on a determination that the gaze of the user with respect to the feature of the virtual reality view of the hotel service being viewed by the user exceeds the specified time duration, modify, based on the analysis of the gaze of the user, the virtual reality view of the hotel service being viewed by the user; and
control, based on the modification of the virtual reality view of the hotel service being viewed by the user, procurement of the hotel service by the user.

19. The non-transitory computer readable medium according to claim 18, wherein the machine readable instructions, when executed by the at least one hardware processor, further cause the at least one hardware processor to:
based on a determination that the gaze of the user with respect to the feature of the virtual reality view of the hotel service being viewed by the user is less than the specified time duration, delay modification, based on the analysis of the gaze of the user, of the virtual reality view of the hotel service being viewed by the user until the gaze of the user with respect to the feature of the virtual reality view of the hotel service being viewed by the user meets or exceeds the specified time duration.

20. The non-transitory computer readable medium according to claim 18, wherein the machine readable instructions to generate, based on the ascertained attribute and the ascertained preference, and based on the virtual reality device, the virtual reality view of the hotel service of the plurality of hotel services offered by the hotel services provider, when executed by the at least one hardware processor, further cause the at least one hardware processor to:
generate, based on the ascertained attribute that includes at least one of an age of the user, a gender of the user, or a location of the user, and based on the virtual reality device, the virtual reality view of the hotel service of the plurality of hotel services offered by the hotel services provider.
